(19) United States
(12) Patent Application Publication
(10) Pub. No.: US 2026/0134406 A1
(43) Pub. Date: May 14, 2026

(54) System and Method for Recycling Plastic Waste

(71) Applicants: Daniel L. Bates, Manhattan Beach, CA (US); Ann Keasman, Big Bear Lake, CA (US); Christopher S. Galazzi, Orleans, MA (US); John Patrick Yonce, Scituate, MA (US)

(72) Inventors: Daniel L. Bates, Manhattan Beach, CA (US); Ann Keasman, Big Bear Lake, CA (US); Christopher S. Galazzi, Orleans, MA (US); John Patrick Yonce, Scituate, MA (US)

(73) Assignee: Clean-Seas, Inc., Manhattan Beach, CA (US)

(21) Appl. No.: 19/444,026

(22) Filed: Jan. 8, 2026

Related U.S. Application Data
(63) Continuation-in-part of application No. 18/451,708, filed on Aug. 17, 2023.

(51) Int. Cl. G06Q 10/30; G06Q 10/04; G06Q 10/0631; G06Q 10/087; G06Q 30/018

(52) U.S. Cl. CPC G06Q 10/30; G06Q 10/04; G06Q 10/06315; G06Q 10/08726; G06Q 10/08744; G06Q 30/018; G06Q 2220/00

(57) ABSTRACT

A computer-implemented method and system for optimizing the conversion of plastic waste into commodities is disclosed. The system integrates a global supply chain management level with a local process optimization level. At the global level, a blockchain network is utilized to manage the plastic waste supply chain, including market identification, international contracting, regulatory compliance, and load-balancing of waste distribution to host nations based on processing capacity. This process generates commodities and plastic or carbon credits. At the local level, the system optimizes the chemical recycling process across a network of pyrolysis facilities. Real-time sensor data from pyrolysis equipment is analyzed to determine the chemical composition of polymer mixtures. By comparing this data to a predefined ideal chemical ratio, the system identifies demands for or surpluses of specific polymer types. It then generates routing instructions to transfer necessary polymers between facilities, thereby creating an optimized feedstock for each pyrolysis apparatus.

### TECHNICAL FIELD

This disclosure relates to a system and method for securing, storing and optimally chemically converting the plastic recycling of developed nations to produce environmentally friendly commodities and clean fuels; reduce the volume of plastic deposited into landfills; reduce incineration; mitigate the use of fossil fuel products; and assist developing nations in establishing plastic recycling and development of collection infrastructure.

### BACKGROUND OF THE INVENTION

Global plastic recycling is facing unprecedented challenges. Inadequate processing infrastructure, fewer processing locales, changing laws and conventions, and political circumstances imperil what is already a deficient response to a global problem. It is estimated that since 1950 only 9% of all of the planet's plastic has been recycled. By the same estimates (University of Wisconsin-Madison professor George Huber), 79 percent of plastic remains in the world's landfills and oceans. Discarded plastics are estimated to comprise 19% of all landfilled material and 16% of combusted material.

Developed nations, including the United States, the world's largest generator of recycled plastic, are finding disposal of this material increasingly difficult, due to expensive and inefficient processing capabilities; global conventions responding to environmental implications of international plastic export; and political constraints.

In January 2018 the People's Republic of China, which had been accepting recycled plastic from countries including the U.S., implemented its National Sword policy limiting recyclable imports. As a result, the worldwide recyclables market experienced drastic limits and fewer options for disposal, resulting in a global backlog of plastic. Some of the recyclable material has been rerouted to Southeast Asian countries but the market remains in upheaval, with, at best, plastic floating in waiting ships and at worst, illegal dumping into international waters, or incinerated.

The Basel Convention on hazardous material (Basel Convention) is an international treaty aimed at reducing the movement of hazardous material between nations. In 2019, the Basel Convention amended its treaty to regulate plastic exports. As a result, international shipment of plastic was, as of January 2021, subject to prior written consent between countries party to the convention. The U.S., as a non-party to this convention, is now subject to new liability because most countries will not accept its recycled plastic. In order to ship its recycled plastic, the U.S. must enter prior written agreements with accepting Basel party countries.

Plastic recycling is more difficult than recycling of glass or other materials because plastic products are composed of various plastic types, with varying pigments and other additives. Current mechanical recycling methods—granulating and melting the particles into pellets for further use as an existing polymer—can be an expensive, inefficient and environmentally dirty process. The cost of disposal is rising; in some markets, it is more than US $100 per ton.

The recycling industry is beginning to implement chemical recycling using the pyrolysis process. Pyrolysis converts organic or inorganic material, under pressure and heat, in the absence of oxygen, into the component parts of new products. The oxygen-starved environment does not produce CO2 or other harmful gasses. Pyrolysis can break down waste-plastic polymers into feedstocks that could be recycled into monomers that can be further refined as naphtha precursors used to create new, clean and pure materials, incorporating recycled plastic through a new path of plastic circularity.

New solutions in the trade of recycled plastics focus on the responsible shipping of plastic material to countries that can adequately process it. Plastic processing can be economically valuable to host countries, creating useful commodities and bio-energies.

The Basel Convention determines the types of plastic wastes that are presumed to not be hazardous. The wastes listed in entry include: a group of cured resins; non-halogenated and fluorinated polymers, provided the waste is destined for recycling in an environmentally sound manner and almost free from contamination and other types of wastes; mixtures of plastic wastes consisting of polyethylene (PE), polypropylene (PP) or polyethylene terephthalate (PET) provided they are destined for separate recycling of each material and in an environmentally sound manner, and almost free from contamination and other types of wastes.

### SUMMARY OF THE INVENTION

A computer-implemented method and system manages and optimizes the conversion of plastic waste into valuable commodities.

The system operates on two interconnected levels: a global supply-chain-management level and a local process-optimization level. At the global level, the method establishes a comprehensive supply chain for plastic waste. This includes identifying markets for plastic-waste collection in developed countries, collecting plastic waste from identified markets, and establishing contracts with host nations for processing the waste.

The method uses a blockchain network to manage the entire lifecycle, from inputting initial plastic-waste data to ensuring compliance with international regulations, such as the Basel Convention. The system measures the processing capacity of host nations and uses this data to perform load balancing, ensuring an efficient and equitable distribution of plastic waste for conversion. The conversion process results in the creation of commodities and the generation of plastic or carbon credits, while also delivering social benefits such as energy security and cleantech jobs to the host nations.

The system and method employs a software method that uses data from data sensors, installed along pyrolysis apparatuses within a network of conversion facilities, to analyze chemical reactions for fluid and solid chemical traits of polymers in a plastic recycling process, and uses the analysis results to determine either a deficiency or an abundance of chemicals, relative to an ideal chemical ratio.

The deficiency or abundance of chemicals is then interpreted by the system to determine a deficiency or abundance of specific polymers. Polymers may be in excess in one facility of the network of conversion facilities, but deficient in another facility. The system determines where polymers are deficient and where they're abundant, and manages their availability between facilities. Polymers in deficiency are logged as a demand and polymers in abundance are logged as available stock. The software searches a network of conversion facilities for stock to fill demand, and routes the stock to that location. This dynamic balancing ensures that each pyrolysis apparatus operates with an optimized feedstock, maximizing the quality and yield of the resulting commodities, such as pyrolysis oil and syngas. The entire process, including the origin and destination of transferred polymers, is tracked using the blockchain network, ensuring transparency and traceability throughout the supply chain. Through the blockchain network, the process manages and monitors plastic-waste data to conform with Basel regulations.

In some embodiments, process facilities are joined in a central communication network referred to as a Plastic Conversion Network (PCN), a software-controlled supply chain.

The system uses a defined ideal chemical ratio to determine the aforementioned deficiency or abundance of polymers. This ideal ratio defines one to seven plastic polymers undergoing pyrolysis, which are blended in a complex chemical ratio to produce high-quality plastic pyrolysis oil, optimizing the chemical-recycling process. A software-controlled manufacturing process reads real-time pyrolysis measurements according to a constantly shifting matrix.

An ideal chemical ratio would meet the following optimum norms:
Sulfur: 100 ppm, nitrogen: 400 ppm, chlorine: 200 ppm, fluoride: 5 ppm, bromine: 10 ppm, asphaltenes: 1000 ppm, phosphorus: 30 ppm, silicon: 80 ppm, boron: 2.5 ppm, barium: 1 ppm, iron: 5 ppm, zinc: 1 ppm, sodium: 2.5 ppm, nickel: 1 ppm, aluminum: 2.5 ppm, cadmium: 1 ppm, calcium: 2.5 ppm, copper: 1 ppm, chromium: 1 ppm, tin: 1 ppm, magnesium: 2.5 ppm, manganese: 1 ppm, molybdenum: 1 ppm, silver: 1 ppm, lead: 1 ppm, potassium: 1 ppm, titanium: 1 ppm, vanadium: 1 ppm, paraffin: <30 ppm, naphthene-olefin: <40 ppm, aromatics: <35 ppm, benzene: <60 ppm, toluene: <35 ppm, xylene: <20 ppm, water: <600 ppm.

The ideal chemical ratio of this pyrolysis system is further documented in the following chart:

| | | | |
|---|---|---|---|
| Density at 15° C. | ASTM D-4052 | Kg/m3 | 800 |
| Sulfur | ASTM D-4294 | ppm | 100 |
| Nitrogen | ASTM D-4629 | ppm | 400 |
| Chlorine content, maximum | ASTM D-7536 | ppm | 200 |
| Fluoride content, maximum | ASTM D-7359 | ppm | 5 |
| Bromine content, maximum | ASTM D-7359 | ppm | 10 |
| asphaltenes, maximum | IFP 9313 | ppm | 1000 |
| pour point | ASTM D-97 | ° F. | 80 |
| Metals, maximum | | | |
| Phosphorus Content | ASTM-D-5185 | ppm | 30 |
| Silicon content | ASTM-D-5185 | ppm | 80 |
| Boron content | ASTM-D-5185 | ppm | 2.5 |
| Barium content | ASTM-D-5185 | ppm | 1 |
| Iron content | ASTM-D-5185 | ppm | 5 |
| Zinc content | ASTM-D-5185 | ppm | 1 |
| Sodium content | ASTM-D-5185 | ppm | 2.5 |
| Nickel content | ASTM-D-5185 | ppm | 1 |
| Aluminum Content | ASTM-D-5185 | ppm | 2.5 |
| Cadmium content | ASTM-D-5185 | ppm | 1 |
| Calcium content | ASTM-D-5185 | ppm | 2.5 |
| Copper Content | ASTM-D-5185 | ppm | 1 |
| Chromium Content | ASTM-D-5185 | ppm | 1 |
| Tin Content | ASTM-D-5185 | ppm | 1 |
| Magnesium content | ASTM-D-5185 | ppm | 2.5 |
| Manganese content | ASTM-D-5185 | ppm | 1 |
| Molybdenum content | ASTM-D-5185 | ppm | 1 |
| Silver Content | ASTM-D-5185 | ppm | 1 |
| Lead Content | ASTM-D-5185 | ppm | 1 |
| Potassium content | ASTM-D-5185 | ppm | 1 |
| Titanium content | ASTM-D-5185 | ppm | 1 |
| Vanadium content | ASTM-D-5185 | ppm | 1 |
| Total metal content | — | ppm | 120 |
| Neutralization number | ASTM D-664 | mg KOH/g | 5 |
| T AN, maximum | | | |
| Paraffin content | | % | <30 |
| Naphthene-olefin content | | % | <40 |
| Aromatic content | | % | <35 |
| Diene index | | g/100 g | >.01 |
| Flash point | ASTM D93 | ° C. | <75 |
| Benzene content | | % | <60 |
| Toluene content | | % | <35 |
| Xylene content | | % | <20 |
| Water content | — | ppm | <600 |

### BRIEF DESCRIPTION OF DRAWINGS

FIG. 1 is a diagram of a system and method for the conversion of plastic waste into commodities.

FIG. 2 is a diagram of an iteration of the system.

FIG. 3 is a diagram of a pyrolysis system of the present disclosure.

### DETAILED DESCRIPTION

The present disclosure relates to a computer-implemented system and method for the management, optimization, and conversion of plastic waste into commodities. More specifically, the invention provides a global framework for identifying plastic waste sources in developed markets, ensuring regulatory compliance (e.g., Basel Convention) via blockchain technology, and optimizing the chemical process of pyrolysis across a network of facilities by dynamically balancing polymer feedstocks.

The system comprises a central computing platform having one or more processors and memory, communicatively coupled to a plurality of distributed nodes. These nodes include:
Source Markets, including data terminals located in developed countries identifying waste availability.
A logistics network made up of a tracking systems for transport vessels and trucks.
Host nation facilities, made up of a network of pyrolysis plants located in one or more host nations.
A blockchain network, a distributed ledger system for immutable record-keeping.

In one embodiment, the system identifies markets, typically in developed countries, where plastic waste is generated. Data regarding this waste is collected to generate plastic-waste data. This data may include weight, volume, polymer type, and origin coordinates.

The system integrates regulatory compliance into the supply chain. The system is configured to determine appropriate Basel regulations-international treaties governing the transboundary movement of hazardous wastes.
The system inputs the plastic-waste data into a blockchain network.
Smart contracts within the blockchain establish and verify compliance with Basel regulations before transport is authorized.
This creates an immutable audit trail, ensuring that the transfer of waste from the developed market to the host nation is legal and transparent.

Once contracts are established with a host nation, the system measures the processing capacity of facilities within that nation. The system performs load-balancing, directing the flow of plastic waste to specific facilities based on their real-time measured capacity, ensuring no single facility is overwhelmed while others remain underutilized.

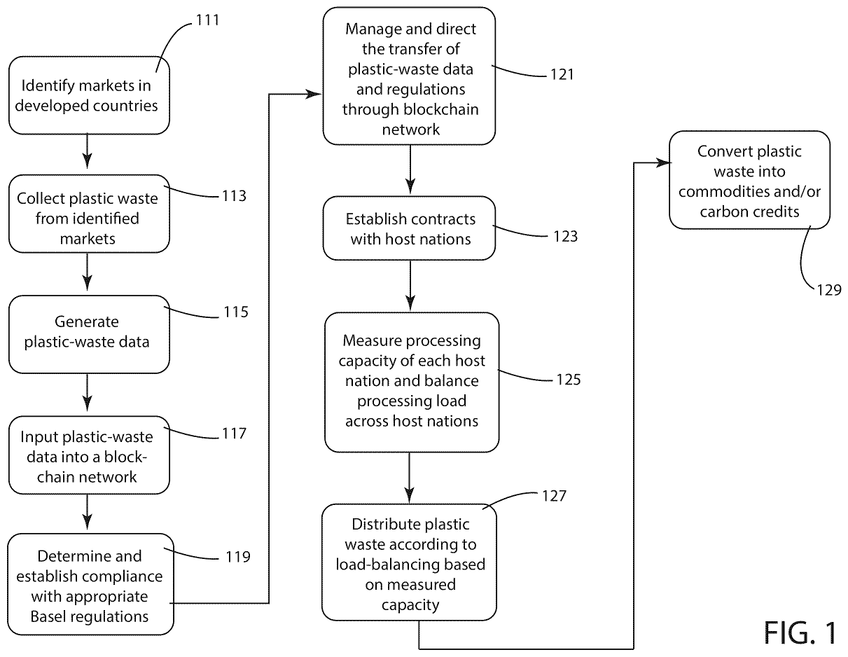

In a diagram of the system and method for the conversion of plastic waste into commodities FIG. 1 shows the steps of:
Identifying markets in developed countries 111;
Collecting plastic waste from identified markets 113;
Generating plastic-waste data 115;
Inputting plastic-waste data into a blockchain network;
Determining appropriate Basel regulations and establishing compliance with those regulations;
Managing and directing the transfer of the plastic-waste data through the blockchain network;
Establishing contracts with host nations;
Measuring host nations' processing capacity;
Balancing processing-capacity load according to measured capacities;
Distributing plastic waste according to this load-balancing;
Converting the plastic waste into commodities or into plastic/carbon credits, offering the host countries social benefits such as energy security, cleantech jobs and local recycling.

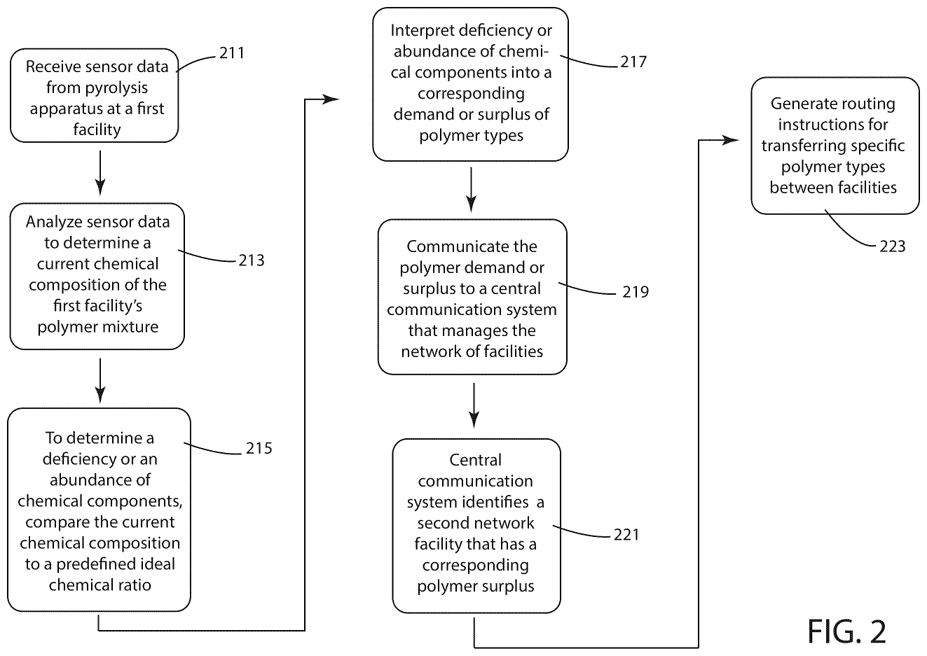

FIG. 2 shows a second iteration in which the system and method:
211 Receive sensor data from a pyrolysis apparatus at a first facility;
213 Analyzes sensor data to determine a current chemical composition of the first facility's polymer mixture;
215 To determine a deficiency or an abundance of chemical components,
compares the current chemical composition to a predefined, ideal chemical ratio;
217 Interprets deficiency or abundance of chemical components into a corresponding demand or surplus of polymer types;
219 Communicates the polymer demand or surplus to a central communication system that manages the network of facilities
221 The central communication system identifies a second network facility that has a corresponding polymer surplus;
223 Generates routing instructions for transferring specific polymer types between facilities.

A significant aspect of the invention is the technical optimization of the conversion process. Plastic waste is converted into commodities such as pyrolysis oil, syngas via pyrolysis. However, the efficiency of pyrolysis and the quality of the resulting oil depend heavily on the chemical composition of the input feedstock.

The system utilizes a network of pyrolysis facilities. At a first facility, a pyrolysis apparatus is equipped with a plurality of sensors.
These sensors measure parameters such as temperature, pressure, density, and chemical concentrations. in many embodiments the sensors are spectroscopic sensors.
The sensors measure target metrics, in an example embodiment they monitor sulfur, nitrogen, chlorine, phosphorus, silicon, and metals.

The processors analyze this real-time data to determine the current chemical composition of the polymer mixture inside the reactor. This is compared to a predefined ideal chemical ratio. In an example embodiment, this ideal ratio comprises.
Sulfur: Maximum concentration of 100 ppm.
°Nitrogen: Maximum concentration of 400 ppm.
Chlorine: Maximum concentration of 200 ppm.
Total Metals: Maximum concentration of 120 ppm.

If the system detects a deficiency or abundance (e.g., the Chlorine level is rising too high because the current batch has too much PVC), the system translates this chemical data into a polymer demand or polymer surplus
An example embodiment may function as follows: If the mix is too acidic (high Chlorine), the system determines a demand for “clean” polymers like Polyethylene to dilute the mixture.
The system recognizes specific types including polyethylene terephthalate (PET), high density polyethylene (HDPE), polyvinyl chloride (PVC), low-density polyethylene (LDPE), linear low-density polyethylene (LLDPE), polypropylene, polystyrene, acrylic, nylon, polycarbonate, and polylactic acid.

The system communicates this demand over the data network to a central communication system. The system then scans a shared network database to identify a second facility in the network that has a surplus of the required polymer.
Upon finding a match, the system generates routing instructions to transfer the specific polymer type from the second facility to the first facility.
This ensures the chemical composition inside the reactor remains optimized for high-quality commodity output.

The conversion process results in commodities such as pyrolysis oil which can be refined into fuel or new plastic, and syngas.

The system calculates the environmental impact. The conversion events are recorded on the blockchain to issue plastic credits and carbon credits. The blockchain tracks the origin typically a developed market, the transfer, also referred to as compliance, and the final destination, usually a conversion facility.

The method is designed to provide specific social benefits to the host nations processing the waste. By establishing these facilities and managing them efficiently, the system provides energy security (via generated syngas/oil), creates cleantech jobs in the operation and maintenance of the facilities, and promotes local recycling ecosystems.

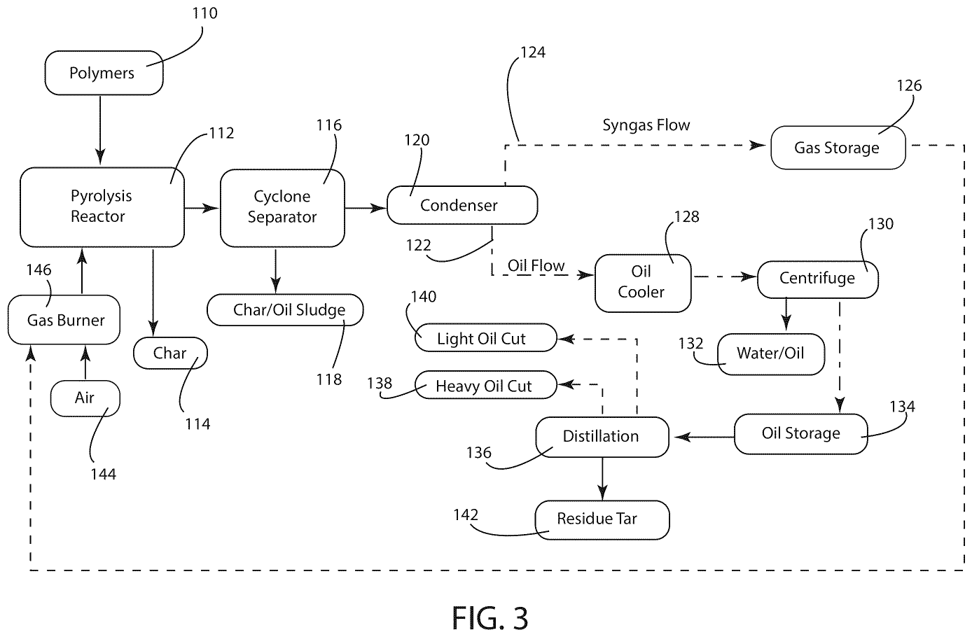

FIG. 3 describes an example apparatus for context. In FIG. 3, polymers 110 are selected, sourced and entered into the pyrolysis reactor 112. Air 144 and heat from a gas burner 146 enter the pyrolysis reactor 112. Material exits the pyrolysis reactor 112 and is moved to a cyclone separator 116 where char and oil sludge 118 are separated out while remaining material is sent to a condenser 120 that separates out syngas, which flows along dashed line 124, and oil, which flows along a second dashed line 122. Syngas flows into a gas storage container 126 and is used to combine with gas burner 146 and air 144 to continue to power the pyrolysis reactor 112. Oil flow 122 continues to an oil cooler 128, where it is sent to a centrifuge 130 where watery oil 132 is separated out and oil is sent to an oil-storage container 134. Oil is then sent through a distillation process 136 where it is separated into heavy oil 138, light oil 140 and residue tar 142.

Sensors at locations 112, 114, 116, 118, 120, 126, 132, 138, 140, and 142 feed data into the method's software-controlled chemical pyrolysis-process assessment system, collecting data from each pyrolysis manufacturing system, using multiple air, liquid, solid, and gas sensors to generate data on the temperature, pressure volatility, BTU, time present, and concentration density of sulfur, nitrogen, chlorine, fluoride, bromine, pour-point, phosphorous, silicon, mercury, arsenic, lead, boiling point, calorific value, asphaltenes, barium, iron, zinc, sodium, nickel, aluminum, cadmium, calcium, copper, chromium, tin, manganese, molybdenum, potassium, titanium, vanadium, paraffin, naphthene-olefin, aromatic, diene index, flash point, benzene, toluene, xylene, butadiene, and water, and a maximum concentration of total metals of 120 ppm.

Based on this sensor-collected data, the network's processors compare each chemical composition undergoing pyrolysis with a predefined ideal chemical ratio to determine a deficiency or an abundance of one or more chemical components. The system and method assesses the demand needs of pyrolysis facilities in the network and determines, by the one or more processors, a deficiency or abundance of the chemical components and a corresponding polymer demand for, or a polymer surplus of, one or more specific polymer types. Specifically, the system and method communicates the polymer demand or the polymer surplus to a central communication system that manages the network's facilities. It then identifies, by the one or more processors via the central communication system, a second facility in the network having a corresponding polymer surplus. The system's processors then generate routing instructions for transferring a quantity of polymer types from the second facility to the first facility to satisfy the polymer demand.

The method determines the optimal routing of available recycled plastic supply, at the optimized polymer level from suppliers, across all PCN processing facilities, to direct the optimized blend of polymer supply to each of the pyrolysis sites, while simultaneously tracking the origin and destination of the recycled plastic using blockchain technology.

The density/percentage of the aforementioned chemicals is interpreted into a deficiency of or abundance of plastics chosen from the group: polyethylene terephthalate, high density polyethylene, polyvinyl chloride, low-density polyethylene, linear low-density polyethylene, polypropylene, polystyrene, acrylic, nylon, polycarbonate, and polylactic acid.

The resultant deficiencies are logged into a PCN as demand and resultant abundances are listed as available stock. The PCN then fulfills that demand with available stock.

1. A computer-implemented method for the conversion of plastic waste into commodities, the method comprising:
identifying markets in developed countries; and
collecting plastic waste from identified markets; and
generating plastic-waste data; and
inputting plastic-waste data into a blockchain network; and
determining appropriate Basel regulations; and
establishing compliance with said Basel regulations; and
managing and directing the transfer of said plastic-waste data and said Basel regulations through said blockchain network; and
establishing contracts with at least one host nation; and
measuring processing capacity of said at least one host nation; and
balancing processing-capacity load according to said measured capacity; and
distributing said plastic waste according to said load-balancing, based on said measured capacity; and
converting said plastic waste into commodities; and
converting said plastic waste into plastic/carbon credits; wherein
social benefits including energy security, cleantech jobs and local recycling are provided to host nations.

2. A computer-implemented method for optimizing the conversion of plastic waste into commodities across a network of pyrolysis facilities, the method comprising:
receiving, by one or more processors, real-time sensor data from a plurality of sensors installed on a pyrolysis apparatus at said first facility, said sensor data corresponding to a plurality of chemical components of a polymer mixture undergoing pyrolysis; and
analyzing, by the one or more processors, the received sensor data to determine a current chemical composition of said polymer mixture; and
comparing, by the one or more processors, the current chemical composition to a predefined ideal chemical ratio to determine a deficiency or an abundance of one or more chemical components; and
interpreting, by the one or more processors, the determined deficiency or abundance of the one or more chemical components into a corresponding polymer demand for, or a polymer surplus of, one or more specific polymer types; and
communicating, by the one or more processors over a data network spanning the network of pyrolysis facilities, the polymer demand or the polymer surplus to a central communication system managing a plurality of facilities within the network; and
identifying, by the one or more processors via the central communication system, a second facility in the network of pyrolysis facilities having a corresponding polymer surplus that matches the polymer demand of the first facility; and
generating, by the one or more processors, routing instructions for transferring a quantity of the one or more specific polymer types from the second facility to the first facility to satisfy the polymer demand.

3. The method of claim 2 wherein:
The predefined ideal chemical ratio comprises a maximum concentration for sulfur of 100 ppm, a maximum concentration for nitrogen of 400 ppm, a maximum concentration for chlorine of 200 ppm, and a maximum concentration for total metals of 120 ppm.

4. The method of claim 2 wherein:
the one or more specific polymer types are selected from a group consisting of polyethylene terephthalate, high density polyethylene, polyvinyl chloride, low-density polyethylene, linear low-density polyethylene, polypropylene, polystyrene, acrylic, nylon, polycarbonate, and polylactic acid.

5. The method of claim 2 wherein:
the plurality of chemical components measured by the sensor data includes one or more of temperature, pressure, density, and concentration of at least one of sulfur, nitrogen, chlorine, phosphorus, silicon, or a metal.

6. The method of claim 2 wherein:
The step of communicating further comprises logging the polymer demand in a shared network database and logging the polymer surplus as an available stock in said shared network database.

7. The method of claim 2 further comprising:
tracking an origin and a destination of the transferred quantity of the one or more specific polymer types using a blockchain network.

8. The method of claim 7 wherein:
The blockchain network further stores data related to compliance with Basel regulations for the transfer of the one or more specific polymer types between different countries.

9. The method of claim 2 wherein:
The commodities produced by the pyrolysis apparatus include pyrolysis oil and syngas.

10. A computer-implemented method for managing a global supply chain for plastic waste conversion, the method comprising:
identifying, by one or more processors, a market for plastic waste collection; and
generating, by the one or more processors, plastic-waste data corresponding to collected plastic waste; and
recording, by the one or more processors, the plastic-waste data and data corresponding to applicable Basel regulations on a blockchain network; and
establishing, by the one or more processors, a contract with a host nation for processing the collected plastic waste, said contract being managed via the blockchain network; and
directing, by the one or more processors, a transfer of the collected plastic waste to the host nation based on a measured processing capacity of the host nation; and
tracking, by the one or more processors, a conversion of the transferred plastic waste into one or more commodities and carbon credits.

11. The method of claim 10 further comprising:
load-balancing the distribution of specific types of plastic waste to a plurality of facilities within the host nation based on the measured processing capacity of each of the plurality of facilities.
